(19) United States
(12) Patent Application Publication
(10) Pub. No.: US 2009/0121965 A1
(43) Pub. Date: May 14, 2009

(54) SPHERICAL ANTENNA

(75) Inventor: Romain Palmade, Auriol (FR)

Correspondence Address: FISH & RICHARDSON P.C., PO BOX 1022, MINNEAPOLIS, MN, 55440-1022, US

(73) Assignee: ATMEL CORPORATION, San Jose, CA (US)

(21) Appl. No.: 11/939,238

(22) Filed: Nov. 13, 2007

(51) Int. Cl. H01Q 7/00; H01Q 21/00

(52) U.S. Cl. 343/867

(57) ABSTRACT

An antenna comprises a first circular coil, a second circular coil, and a third circular coil, and a housing unit including a sending/receiving interrogator chip. The first, second, and third coil are each connected to the housing unit at two points on each of the first, second, and third coil, and the first, second, and third coil are connected substantially in parallel.

### TECHNICAL FIELD

This disclosure relates to an antenna.

### BACKGROUND

Smart cards or radio frequency identification (RFID) cards are generally pocket sized devices that contain integrated circuits (ICs) that can store and/or process information. One type of smart card is the contactless smart card, in which the IC communicates with a card reader through RFID induction technology. These cards generally approximate the dimensions of a credit card, and require only close proximity to an antenna to complete a transaction. They are often used when transactions are processed quickly or hands-free, such as on mass transit systems or security access systems, where smart cards can be used without even removing them from a wallet. These cards require the antenna embedded in an inlay to be flat so the antenna can fit on a flat card.

### SUMMARY

In one implementation, an antenna comprises a first substantially circular coil, a second substantially circular coil, and a third substantially circular coil, and a housing unit including an interrogator chip. The first, second, and third substantially circular coil are each connected to the housing unit at two points on each of the first, second, and third coil, and the first, second, and third coil are connected substantially in parallel.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an example spherical antenna for contactless chips.

FIG. 2 shows an example micro-module for contactless chips.

FIG. 3 shows an example communication system that includes a spherical antenna for contactless chips.

FIG. 4 shows a flow chart of an example process for constructing a spherical antenna for contactless chips.

### DETAILED DESCRIPTION

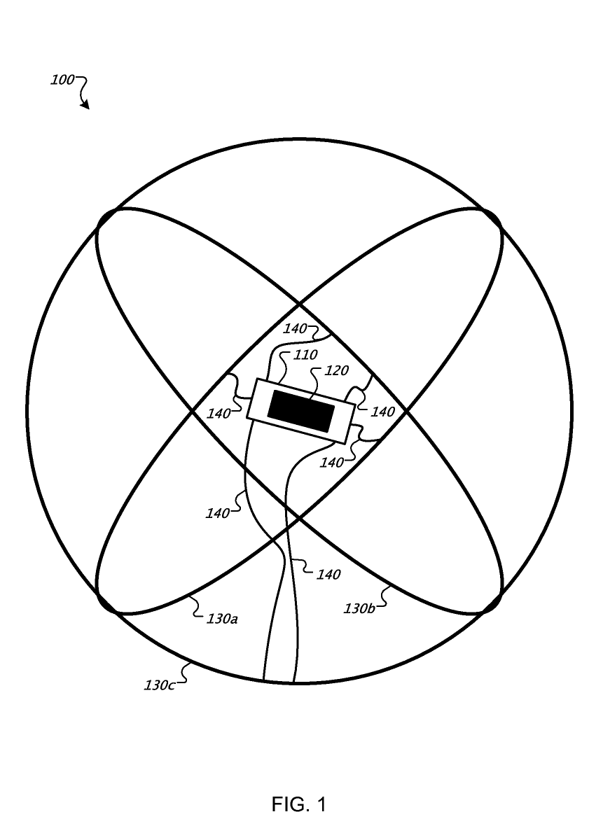

FIG. 1 shows an example spherical antenna 100 for contactless chips. In general, the spherical antenna is used in radio frequency identification (RFID), near field, and other forms of radio communications. The spherical antenna 100 is able to communicate with communication transceivers while the spherical antenna 100 is held in substantially any orientation.

The spherical antenna 100 includes a micromodule 110. The micro-module 110 is a housing that includes an integrated circuit (IC) 120. The IC 120 includes circuitry for storing and/or processing information, modulating and demodulating radio frequency (RF) signals, interrogation, and/or other specialized functions.

The spherical antenna 100 includes coils 130a-130c. The coils 130a-130c are substantially circular antenna coils that are oriented such that each one of the coils 130a-130c is oriented substantially perpendicular to the other two of the coils 130a-130c. Each of the coils 130a-130c acts as a loop antenna for the radio transceiver circuitry of the IC 120. Loop antennas generally have a continuous conducting path leading from one conductor of a two-wire transmission line to the other conductor, and are directional antennas with a sharp null with a radiation pattern similar to dipole antennas. In one implementation, each of the coils 130a, 130b, and 130c are at approximately 90 degree angles to each other. In some implementations, the coils 130a-130c are non-circular coils. In other implementations, coils 130a-130c are not necessary circular.

A loop antenna is generally considered to be a “small” loop if it is less than ¼ of a wavelength of the intended frequency of operation in circumference, and some directional receiving loops are approximately 1/10 of a wavelength. Small loop antennas can also be called magnetic loop antennas because small loops can be more sensitive to the magnetic component of the electromagnetic wave. As such, small loop antennas can be less sensitive to near field electric noise when properly shielded when compared to other types of antennas. In some implementations, the received voltage of a small loop can be greatly increased by bringing the loop into resonance with a tuning capacitor.

Since the small loop is small with respect to a wavelength, the current around the antenna is nearly completely in phase. Therefore, waves approaching in the plane of the loop will cancel, and waves in the axis perpendicular to the plane of the loop will be strongest.

Individually, each of the coils 130a-130c can receive and/or radiate RF energy in a pattern that is substantially perpendicular to the plane of the coil. By orienting the coils 130a-130c in mutually perpendicular orientations, the spherical antenna 100 can receive and/or radiate RF energy in a substantially omnidirectional pattern. Each one of the coils 130a-130c is connected to the IC 120 by a collection of pairs of electrical conductors 140. In some implementations, the coils 130a-130c are electrically connected substantially in parallel. In some implementations, the electrical conductors 140 can be wires.

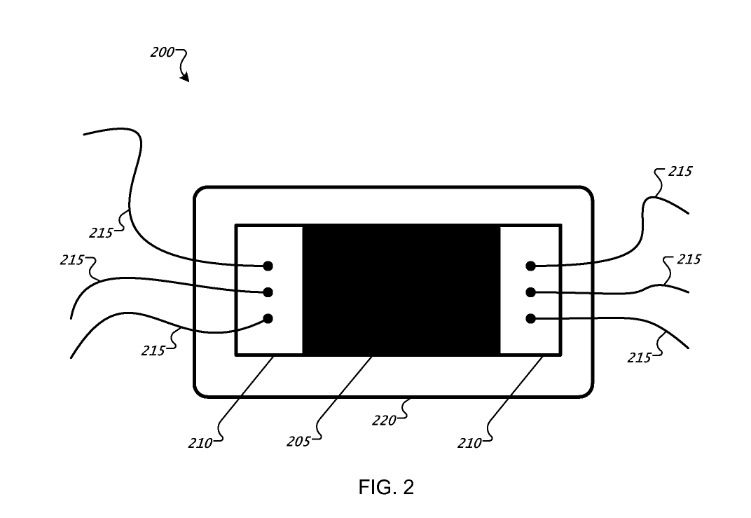

FIG. 2 shows an example micro-module 200 for contactless chips. In some implementations, the micro-module 200 may be the micro-module 110 of FIG. 1. The micro-module 200 includes an IC 205. The IC 205 is an integrated circuit that includes circuitry for transmitting and/or receiving RF signals. In some implementations, the IC 205 can also include circuitry for processing, data storage, sensing, and/or other functions.

The micro-module 200 also includes a pair of electrical contacts 210. The electrical contacts 210 are electrically conductive areas that are in electrical communication with the IC 205. A collection of electrical conductors 215 (e.g., wires) are electrically connected between the electrical contacts 210 and electrical coils such as the coils 130a-130c. In some implementations, the electrical conductors 215 are electrically connected to the electrical contacts 210 by soldering. In some implementations, the electrical conductors 215 electrically connect the coils 130a-130c in parallel to the IC 205.

The IC 205 and the electrical contacts 210 are housed in a carrier 220. In some implementations, the carrier 220 can be a transfer-molded package based on a continuous lead frame. In some implementations, the carrier 220 can be packaged into a smartcard or RF transponder application. In some implementations, the coils 130a-130c can be constructed as a sphere, or other shape that can enclose the partial sphere formed by the mutually perpendicularly orientated coils 130a-130c previously described with respect to FIG. 1. For example, the carrier 220 may be located within the sphere formed by the coils 130a-130c and be molded into a key fob, a money clip, a zipper pull, a badge, an article of jewelry, or other shape that may be used to enclose the sphere.

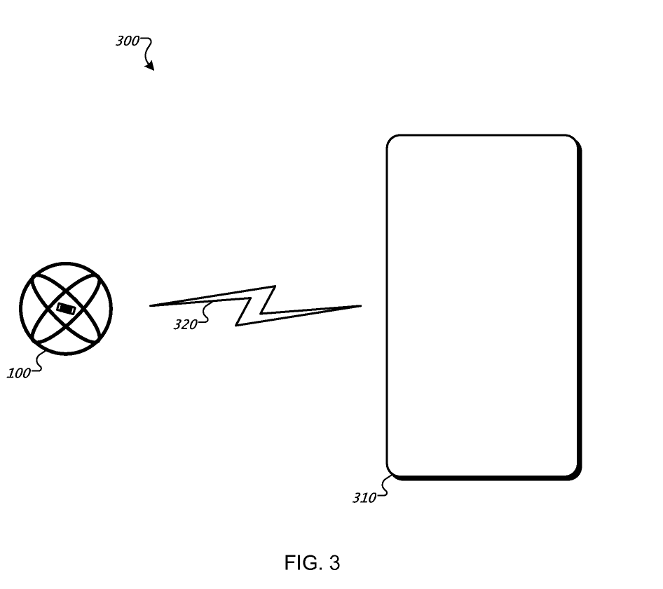

FIG. 3 shows an example communication system 300 that includes the spherical antenna 100 for contactless chips. The spherical antenna 100 communicates with a communication transceiver 310 over a communications link 320. The communications link 320 can, for example, include an RF communications link. The communication transceiver 310 includes circuitry that provides transmitter and receiver functions to communicate with the spherical antenna 100 over the communications link 320. In some implementations, the communication transceiver 310 can also include additional circuits to provide additional functionality for identification, security, tracking, or other functions that may be associated with an RFID transceiver.

The omnidirectional nature of the spherical antenna 100 provides the spherical antenna 100 the ability to communicate with the communication transceiver 310 without regard to the orientation of the spherical antenna 100. For example, the spherical antenna 100 can confirm authority of a housing unit which the antenna is embedded to unlock a door. The spherical antenna 100 can, for example, receive, process, and emit an RF signal to the transceiver 310 and optionally unlock the door. The spherical antenna 100 is able to communicate with the communication transceiver 310 without requiring that the spherical antenna be positioned in any specific orientation relative to the communication transceiver 310.

In some implementations, the spherical antenna 100 can be deployed to track person and animals that carry an RFID tag where the tracked objects may be of a nature that would make it difficult or impractical to ensure that the RFID tags are held in any particular orientation relative to the communication transceiver 310. For example, a number of the communication transceivers 310 may be deployed at various locations in a stockyard (e.g., entrances, exits, gates) to track the locations of livestock that have been marked with identification tags that include the spherical antennas 100. Similarly, a number of the communication transceivers 310 may be installed in various locations along a materials handling system (e.g., manufacturing line, airport luggage transport system, parcel delivery system) to track the location of materials (e.g., luggage, mail, packages) as they are processed.

In some implementations, the spherical antenna 100 is embedded in a spherical electromagnetically transparent ball. The ball can, for example, be made of a plastic material.

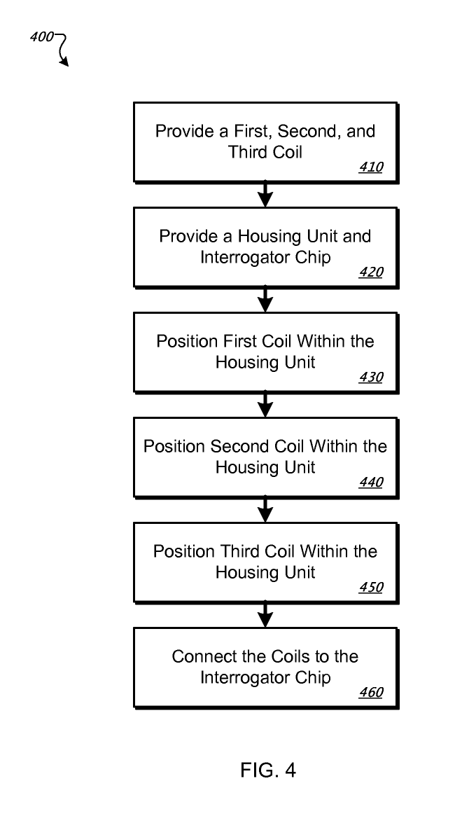

FIG. 4 shows a flow chart of an example process 400 for constructing a spherical antenna for contactless chips. In some implementations, the spherical antenna can be the spherical antenna 100. The construction of the spherical antenna begins by providing at 410 a first, a second, and a third antenna coils. In some implementations, the three antenna coils can be substantially circular loops of electrically conductive material (e.g., wire). A housing unit and an interrogator chip are provided at 420 to be combined with the three antenna coils. In some implementations, the interrogator chip can be capable of sending and/or receiving RF signals, such as an RFID chip.

The first coil is positioned at 430 within the housing unit. The second coil is then positioned at 440 within the housing unit, such that the second loop substantially bisects the plane of the first coil at a substantially perpendicular angle. The third coil is then positioned at 450 within the housing unit such that the third coil bisects the planes of first and second coils at angles of approximately 90 degrees. For example, when the first, second, and third coils are positioned within the housing unit according to the process 400, the three coils can form a sphere, and the planes of the coils can divide the sphere into eight substantially identical sections. The three coils are connected at 460 to the interrogator chip such that the interrogator chip is electrically connected to two points on each of the three coils.

In some implementations, the housing unit can be shaped as a sphere, or as any other shape that can enclose the sphere formed by the three coils. In some implementations, the housing unit may be made of plastic, glass, or other electromagnetically transparent materials. In some implementations, the housing unit may be a micro-module, such as the micro-module 200.

Individually, each of the three coils can form an electromagnetic pattern that radiates substantially perpendicular from the planes of the coils. By positioning the coils in the described positions (e.g., mutually perpendicular to each other, at approximately 90 degree angles to each other), an antenna can be formed to have a substantially spherical electromagnetic field.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. An antenna, comprising:
a first substantially circular coil, a second substantially circular coil, and a third substantially circular coil;
a housing unit including an interrogator chip;
wherein the first, second, and third coil are each connected to the housing unit at two points on each of the first, second, and third coil, and wherein the first, second, and third coil are connected in substantially in parallel.

2. The antenna of claim 1, wherein the first and second coil are disposed at an angle of approximately 90 degrees.

3. The antenna of claim 1, wherein the first and third coil are disposed at an angle of approximately 90 degrees.

4. The antenna of claim 1, wherein the second and third coil are disposed at an angle of approximately 90 degrees.

5. The antenna of claim 1, wherein the antenna is embedded in a spherical electromagnetically transparent ball.

6. The antenna of claim 1, wherein the chip is an RFID chip.

7. The antenna of claim 1, wherein the housing unit is a micromodule.

8. An antenna in a radio frequency identification system, the antenna comprising:
a first substantially circular coil, a second substantially circular coil, and a third substantially circular coil, the first, second, and third substantially circular coils oriented such that the first coil is oriented at approximately a 90 degree angle to the second coil, the second coil is oriented at approximately a 90 degree angle to the third coil, and the first coil is oriented at approximately a 90 degree angle to the third coil; and
a micromodule including an interrogator chip, wherein a spherical shaped electromagnetic field is created centered about each coil and resulting in a spherical electromagnetic pattern.

9. The antenna of claim 8, wherein the antenna is embedded in an electromagnetically transparent ball.

10. The antenna of claim 8, wherein the chip is an RFID chip.

11. A method, comprising:
providing a first circular coil, a second circular coil, and a third circular coil;
providing a housing unit including a sending/receiving interrogator chip;
positioning the first, second, and third coil within the housing unit such that each coil is connected to the housing unit at two points on each of the first, second, and third coil, and
electrically connecting each of the first, second, and third coil substantially in parallel.

12. The method of claim 11, wherein the first and second coil are disposed at an angle of approximately 90 degrees.

13. The method of claim 11, wherein the first and third coil are disposed at an angle of approximately 90 degrees.

14. The method of claim 11, wherein the second and third coil are disposed at an angle of approximately 90 degrees.

15. The method of claim 11, wherein the antenna is embedded in a spherical electromagnetically transparent ball.

16. The method of claim 11, wherein the chip is an RFID chip.

17. The method of claim 11, wherein the housing unit is a micromodule.

18. A method, comprising:
providing a first circular coil, a second circular coil, and a third circular coil, the first, second, and third circular coils oriented such that the first coil is oriented at approximately a 90 degree angle to the second coil, the second coil is oriented at approximately a 90 degree angle to the third coil, and the first coil is oriented at approximately a 90 degree angle to the third coil, thereby creating a spherical shaped electromagnetic field centered about each coil and resulting in a spherical electromagnetic pattern; and
providing a micromodule including a sending/receiving interrogator chip.

19. The method of claim 18, wherein the antenna is embedded in an electromagnetically transparent ball.

20. The method of claim 18, wherein the chip is an RFID chip.

21. A smart card, comprising:
a housing unit including an interrogator chip; and
an antenna, comprising:
first substantially circular coil, a second substantially circular coil, and a third substantially circular coil, wherein the first, second, and third coil are each connected to the housing unit at two points on each of the first, second, and third coil, and wherein the first, second, and third coil are connected substantially in parallel.

22. The smart card of claim 21, wherein the first and second coil are disposed at an angle of approximately 90 degrees.

23. The smart card of claim 22, wherein the first and third coil are disposed at an angle of approximately 90 degrees.

24. The smart card of claim 22, wherein the second and third coil are disposed at an angle of approximately 90 degrees.

25. The smart card of claim 22, wherein the chip is an RFID chip.
